(19) United States
(12) Patent Application Publication
(10) Pub. No.: US 2005/0066367 A1
(43) Pub. Date: Mar. 24, 2005

(54) Integrated receiver decoder for receiving digitally modulated signals from a satellite

(76) Inventors: Gregory James Fyke, Austin, TX (US); Ramin Khoini-Poorfard, Austin, TX (US); James Martin Nohrden, Lakeway, TX (US); Scott Woodford, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 10/664,554

(22) Filed: Sep. 19, 2003

(51) Int. Cl. H04N 7/20

(52) U.S. Cl. 725/68; 725/70

(57) ABSTRACT

An integrated receiver decoder for receiving digitally modulated signals from a satellite is disclosed. The receiver includes a tuner, a demodulator, a low-noise block (LNB) controller, a voltage controller and a voltage selector implemented within a single monolithic integrated circuit device. The tuner amplifies and filters satellite signals received from a directional receiver antenna. The demodulator, which is coupled to the tuner, demodulates and decodes the received satellite signals. The LNB controller generates and detects a modulated tone to facilitate communications between the receiver and an LNB feed attached to the directional receiver antenna. The voltage selector directs the voltage controller to provide a control signal for controlling an external voltage regulator to generate a variable voltage to the LNB feed attached to the directional receiver antenna.

### BACKGROUND OF THE INVENTION

1. Technical Field

The present invention relates to receivers in general, and in particular to satellite receivers. Still more particularly, the present invention relates to a satellite receiver for receiving digitally modulated broadcast signals from a satellite.

2. Description of the Related Art

In general, digital television signals are digitally modulated when broadcast over a digital satellite communication system using phase-shift keyed modulation schemes. The digital satellite communication system typically employs a ground-based transmitter that beams an uplink signal to a satellite positioned in a geosynchronous orbit. In turn, the satellite relays the signal back to various ground-based receivers. Such digital satellite communication system permits a household (or business) subscribing to a satellite television service to receive audio and video signals directly from the satellite by means of a directional receiver antenna that is affixed to the roof or an external wall of the subscriber's residence. A directional receiver antenna constructed to receive satellite signals typically includes a dish-shaped reflector that has a feed support arm protruding outward from the front surface of the reflector. The feed support arm supports an assembly in the form of a low-noise block (LNB) amplifier having an integrated LNB feed. The reflector collects and focuses satellite signals onto the LNB feed.

The satellite signals are typically received at Ku-band or C-band. The received satellite signals are first amplified and then downshifted to a predetermined frequency band, typically in the L-band, between the range of 950 MHz and 2150 MHz. The downshifting function is typically performed within the LNB. The satellite signals are then sent via a coaxial cable to a set-top box unit located adjacent to the subscriber's television. The satellite signal received at the set-top box maybe further downshifted to a predetermined intermediate frequency for amplification, bandpass filtering to eliminate adjacent channels and other functions such as automatic gain control, etc., with a subsequent or second down conversion to baseband and recovery of the phase-shift keyed modulated data.

The present disclosure provides an improved satellite receiver for receiving digitally modulated broadcast signals from a satellite.

### SUMMARY OF THE INVENTION

In accordance with a preferred embodiment of the present invention, a receiver for receiving digitally modulated broadcast signals from a satellite includes a tuner, a demodulator, a low-noise block (LNB) controller, a voltage controller and a voltage selector implemented within a single monolithic integrated circuit device. The tuner amplifies and filters satellite signals received from a directional receiver antenna. The demodulator, which is coupled to the tuner, demodulates and decodes the received satellite signals. The LNB controller generates and detects a modulated tone to facilitate communications between the receiver and an LNB feed attached to the directional receiver antenna. The voltage selector directs the voltage controller to provide a control signal for controlling a power transistor to generate a variable voltage to the LNB feed attached to the directional receiver antenna.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a digital satellite broadcasting system to which a receiver in accordance with a preferred embodiment of the present invention is applicable;

FIG. 2 is a conceptual block diagram of a satellite broadcasting receiver, in accordance with a preferred embodiment of the present invention;

FIG. 3 is a block diagram of an LNB supply implemented by a DC-DC converter, according to the prior art;

FIG. 4 is a functional block diagram of a receiving module of a satellite broadcasting receiver, in accordance with a preferred embodiment of the present invention; and

FIG. 5 is a circuit diagram of the current sensor and the voltage sensor from FIG. 4, in accordance with a preferred embodiment of the present invention.

### DETAILED DESCRIPTION OF A PREFERRED EMBODIMENT

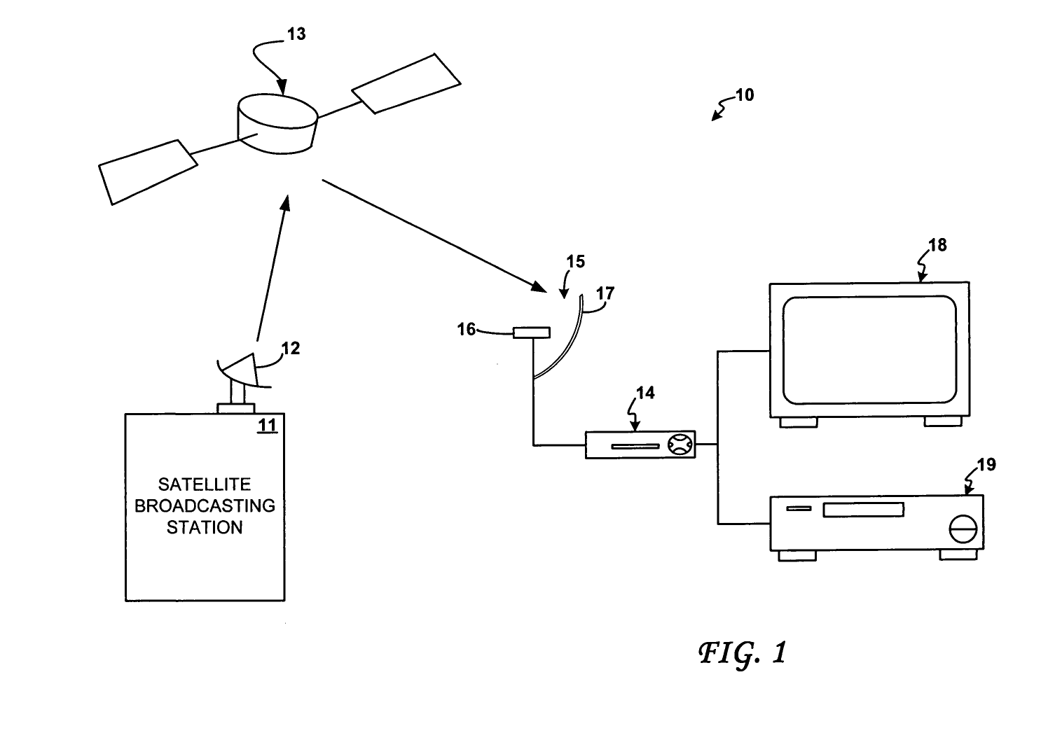

Referring now to the drawings and in particular to FIG. 1, there is depicted a block diagram of a digital satellite broadcasting system to which a receiver in accordance with a preferred embodiment of the present invention is applicable. As shown, a digital satellite broadcasting system 10 includes a satellite broadcasting station 11 having a broadcasting antenna 12 and a broadcasting satellite 13. In digital satellite broadcasting system 10, various television programs furnished by a program purveyor are encoded by a Motion Pictures Expert Group (MPEG) encoder (not shown) to form an MPEG transport stream (MPEG-TS). After being modulated for satellite broadcasting, the MPEG-TS is transmitted to broadcasting satellite 13 from satellite broadcasting station 11 via broadcasting antenna 12. In addition to receiving MPEG-TS, broadcasting satellite 13 is also configured for retransmission of the received MPEG-TS to satellite broadcasting receivers, such as a satellite broadcasting receiver 14 that is installed in the premise of a satellite television service subscriber.

Satellite broadcasting receiver 14 receives modulated satellite signals via a directional receiver antenna 15 that is constructed to receive modulated satellite signals. Preferably, directional receiver antenna 15 includes a dish-shaped reflector 17 that has a feed support arm protruding outward from the front surface of the reflector. The feed support arm supports an assembly in the form of a low-noise block (LNB) amplifier having an integrated LNB feed 16. Reflector 17 collects and focuses modulated satellite signals onto LNB feed 16.

Satellite broadcasting receiver 14, which is also known as an integrated receiver and decoder (IRD) or a set-top box (STB), acts as a reception terminal for receiving modulated satellite signals from directional receiver antenna 15. The modulated satellite signals are subsequently converted to corresponding video and audio signals that can be output on a television 18 and/or a video cassette recorder 19 that are connected to satellite broadcasting receiver 14.

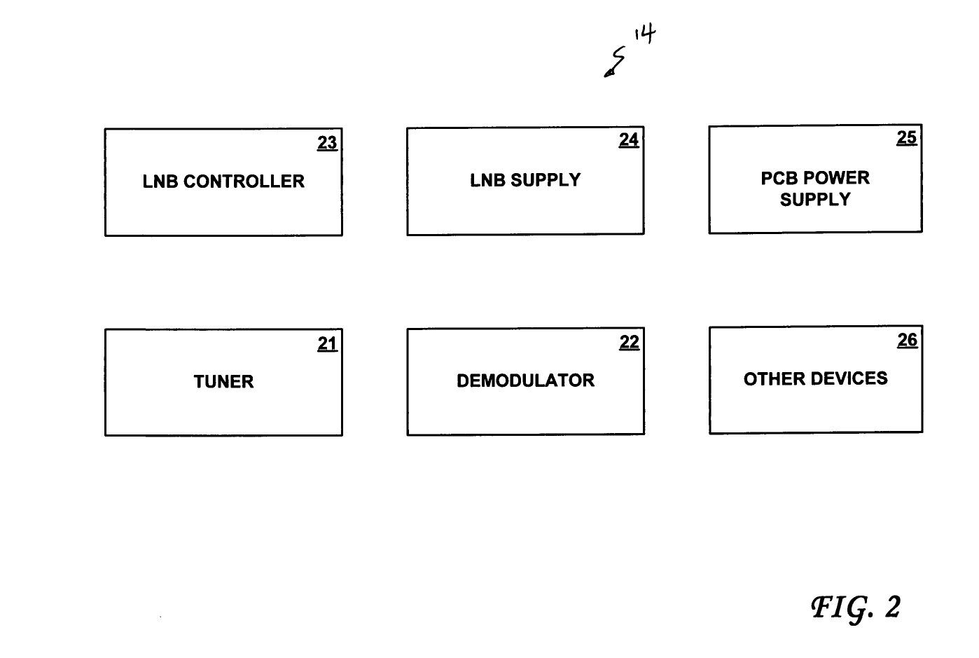

With reference now to FIG. 2, there is illustrated a conceptual block diagram of satellite broadcasting receiver 14, in accordance with a preferred embodiment of the present invention. As shown, satellite broadcasting receiver 14 includes a tuner 21, a demodulator 22, an LNB controller 23, an LNB supply 24 and a PCB power supply 25 along with other devices 26. Tuner 21 amplifies and filters satellite signals received from a directional receiver antenna. Demodulator 22 demodulates and decodes forward error correction of the received satellite signals. LNB controller 23 generates and detects a 22 kHz pulse-width modulated signal in order to facilitate communications between satellite broadcasting receiver 14 and an LNB feed, such as LNB feed 16 from FIG. 1, attached to the directional receiver antenna. LNB supply 24 supplies a variable voltage to power the LNB feed attached to the directional receiver, antenna.

With the exception of LNB supply 24, most of the above-mentioned components within satellite broadcasting receiver 14 can be implemented within a complementary-metal oxide semiconductor (CMOS) integrated circuit device that requires less than 5 V of supply voltage. This is because LNB supply 24 must be capable of driving voltages in the range of 13 V to 21 V, making integration of LNB supply 24 into a low-voltage CMOS design prohibitive.

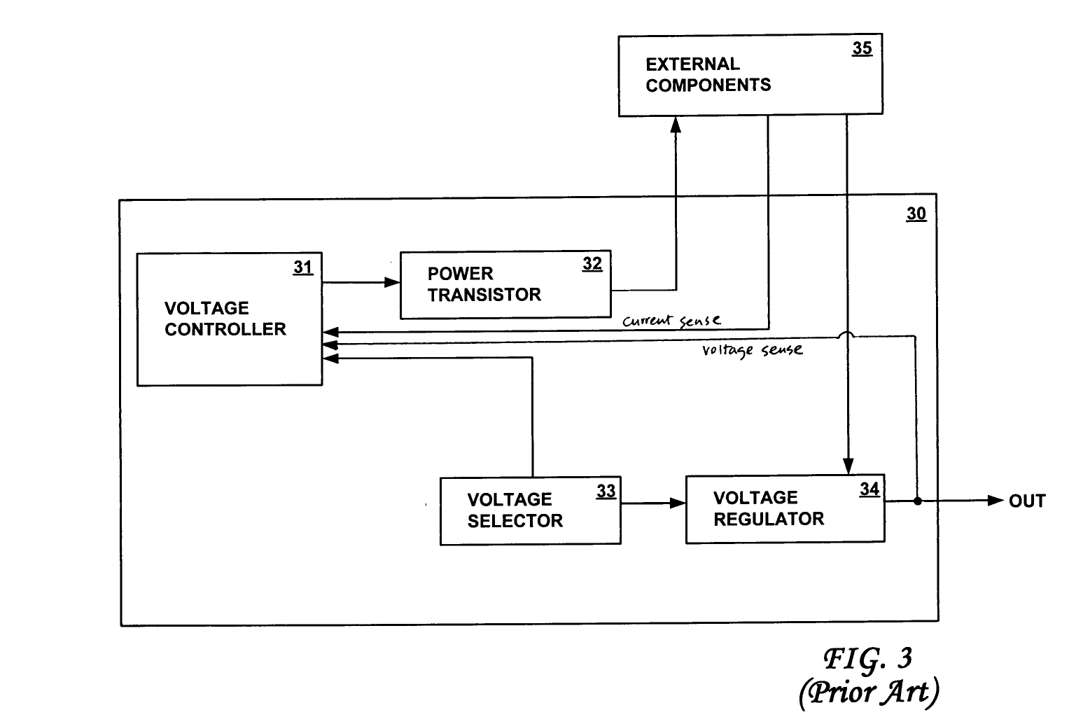

There are several prior art approaches for solving the above-mentioned LNB supply integration problem. For example, a DC-DC converter can be used to implement the LNB supply. Referring now to FIG. 3, there is depicted a block diagram of an LNB supply implemented by a DC-DC converter, according to the prior art. As shown, an LNB supply 30 includes a voltage controller 31, a power transistor 32, a voltage selector 33, and a voltage regulator 34. Voltage controller 31, power transistor 32, voltage selector 33, and voltage regulator 34 are all implemented within a single integrated circuit device. LNB supply 30 is coupled to external components 35 that provide a current sensing feedback to voltage controller 31 within LNB supply 30. In addition, voltage regulator 34 provides a voltage sensing feedback to voltage controller 31 within LNB supply 30.

The approach of implementing an integrated LNB supply with a DC-DC converter, as depicted in FIG. 3, is favorable from the standpoint that no additional requirements is placed on the transformer for LNB supply 30. In addition, the DC-DC converter can be designed to utilize an existing voltage rail on a receiver board. However, the main drawback of implementing an integrated LNB supply with a DC-DC converter is that low-voltage CMOS designs are not permissible. Hence, in the prior art, an LNB supply within a satellite broadcasting receiver is typically implemented as a discrete device separated from other devices within the satellite broadcasting receiver.

In accordance with a preferred embodiment of the present invention, a tuner, a demodulator and a LNB controller and all functionalities of an LNB supply are integrated into a single integrated circuit device, with the exception of a power transistor and a voltage regulator.

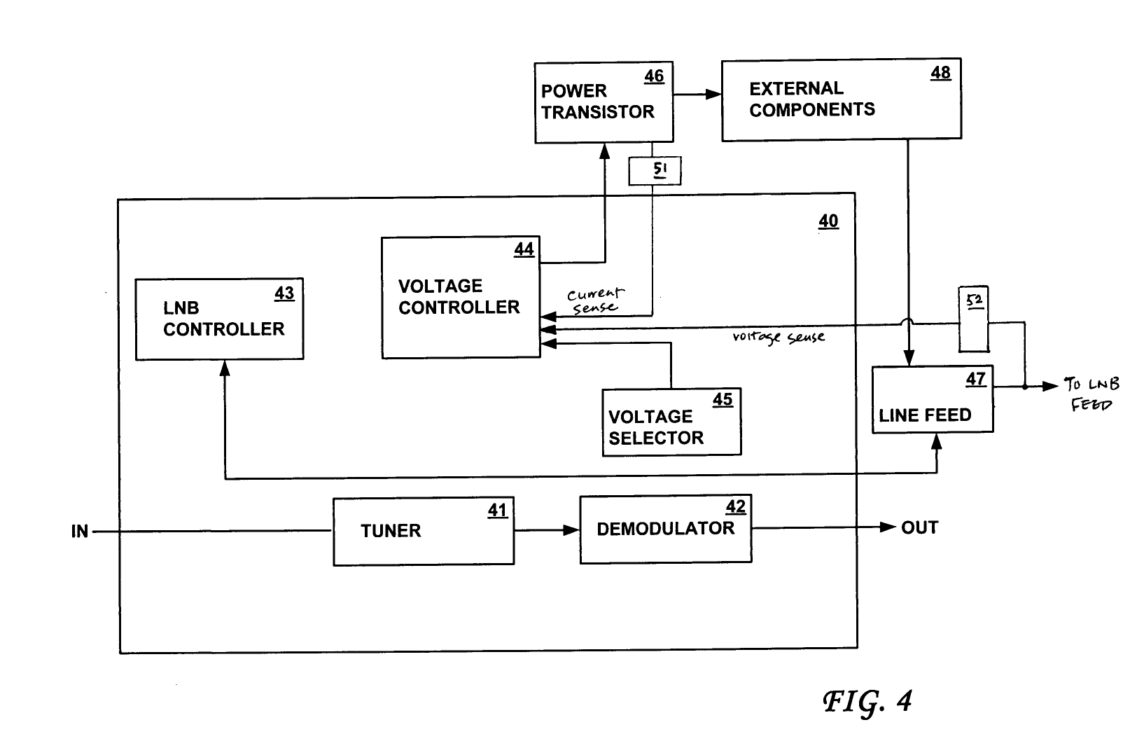

With reference now to FIG. 4, there is depicted a functional block diagram of a receiving module of a satellite broadcasting receiver, in accordance with a preferred embodiment of the present invention. As shown, a receiving module 40 includes a tuner 41, a demodulator 42, an LNB controller 43, a voltage controller 44 and a voltage selector 45. Preferably, receiving module 40 is implemented within a single monolithic integrated circuit device manufactured under the CMOS technology.

As shown, receiving module 40 is coupled to a power transistor 46, a line feed 47 and various external components 48. Specifically, voltage controller 44 is connected to power transistor 46. Also, LNB controller 43 is connected to line feed 47. In addition, a current sensor 51 provides a current sensing feedback from power transistor 46 to voltage controller 44. Similarly, a voltage sensor 52 provides a voltage sensing feedback from line feed 47 to voltage controller 44.

During operation, tuner 41 amplifies and filters satellite signals that are received from a directional receiver antenna. Demodulator 42 then demodulates and decodes forward error correction of the received satellite signals. LNB controller 43 generates and detects a 22 kHz pulse-width modulated signal to facilitate communications between receiving module 40 and an LNB feed (such as LNB feed 16 from FIG. 1) attached to a directional receiver antenna. Voltage controller 44 generates a control signal to power transistor 46. Under the control of LNB controller 43, line feed 47 supplies a variable voltage and a variable current to power the LNB feed attached to the directional receiver antenna.

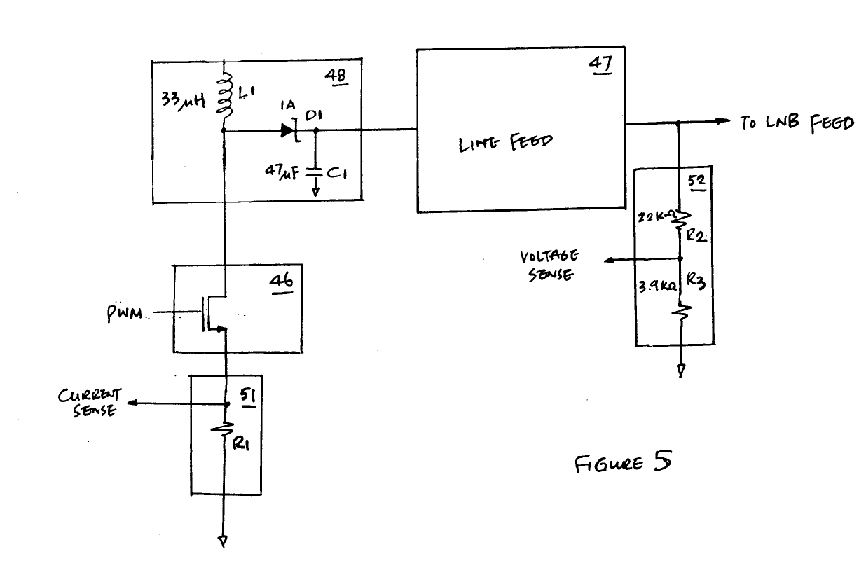

Referring now to FIG. 5, there is depicted a circuit diagram of current sensor 51 and voltage sensor 52, in accordance with a preferred embodiment of the present invention. As shown, current sensor 51 includes a resistor R1 connected between power transistor 46 and ground.

In addition to inductor L1, external components 48 also includes a diode D1 and a capacitor C1. The current from inductor L1 is sent to line feed 47 and power transistor 46. The variable voltage sent to the LNB feed by line feed 47 is measured by voltage sensor 52. Current sensor 52 includes two resistors R2 and R3 connected in series. The output voltage of line feed 47 can be measured via the voltage divider formed by resistors R2 and R3.

As has been described, the present invention provides an improved satellite receiver for receiving digitally modulated broadcast signals from a satellite. The improved satellite broadcasting receiver includes a tuner, a demodulator, an LNB controller, a voltage controller and a voltage selector implemented within a single monolithic integrated circuit device manufactured under the CMOS technology.

While the invention has been particularly shown and described with reference to a preferred embodiment, it will be understood by those skilled in the art that various changes in form and detail may be made therein without departing from the spirit and scope of the invention.

1. An integrated circuit receiver device for receiving digitally modulated broadcast signals from a satellite, said integrated circuit receiver device comprising:
a tuner for amplifying and filtering satellite signals received from said antenna;
a demodulator, coupled to said tuner, for demodulating and decoding said received satellite signals;
a low-noise block (LNB) controller for generating and detecting a modulated tone to facilitate communications between said integrated circuit receiver device and an LNB feed attached to said antenna;
a voltage controller for generating a control signal to an external power transistor; and
a voltage selector for directing said voltage controller to supply a variable voltage to said LNB feed attached to said antenna.

2. The integrated circuit receiver device of claim 1, wherein said voltage controller receives a current sensing feedback from an external current sensor coupled to a power transistor.

3. The integrated circuit receiver device of claim 2, wherein said external current sensor includes a resistor connected between power transistor and ground.

4. The integrated circuit receiver device of claim 2, wherein said external components includes an inductor, a diode and a capacitor.

5. The integrated circuit receiver device of claim 1, wherein said voltage controller receives a voltage sensing feedback from an external voltage sensor coupled to an external line feed.

6. The integrated circuit receiver device of claim 5, wherein said external voltage sensor includes two resistors connected in series.

7. The integrated circuit receiver device of claim 1, wherein said integrated circuit receiver device is a complementary-metal oxide semiconductor device.

8. A satellite signal receiving system for receiving digitally modulated broadcast signals from a satellite, said satellite signal receiving system comprising:
a receiver antenna having a low-noise block (LNB) amplifier and an LNB feed; and
an integrated circuit receiver device having
a tuner for amplifying and filtering satellite signals received from said receiver antenna;
a demodulator, coupled to said tuner, for demodulating and decoding said received satellite signals;
an LNB controller for generating and detecting a modulated tone to facilitate communications between said integrated circuit receiver device and said LNB feed attached to said receiver antenna;
a voltage controller for generating a control signal to an external power transistor; and
a voltage selector for directing said voltage controller to supply a variable voltage to said LNB feed attached to said receiver antenna.

9. The satellite signal receiving system of claim 8, wherein said voltage controller receives a current sensing feedback from an external current sensor coupled to a power transistor.

10. The satellite signal receiving system of claim 8, wherein said external current sensor includes a resistor connected between power transistor and ground.

11. The satellite signal receiving system of claim 9, wherein said external components includes an inductor, a diode and a capacitor.

12. The satellite signal receiving system of claim 8, wherein said voltage controller receives a voltage sensing feedback from an external voltage sensor coupled to an external line feed.

13. The satellite signal receiving system of claim 12, wherein said external voltage sensor includes two resistors connected in series.

14. The satellite signal receiving system of claim 8, wherein said integrated circuit receiver device is a complementary-metal oxide semiconductor device.

15. The satellite signal receiving system of claim 8, wherein said receiver antenna is a directional receiver antenna.
